(19) United States
(12) Patent Application Publication
(10) Pub. No.: US 2017/0343744 A1
(43) Pub. Date: Nov. 30, 2017

(54) OPTICAL CONNECTORS AND RELATED MANUFACTURING TECHNIQUES

(71) Applicant: Lattice Semiconductor Corporation, Portland, OR (US)

(72) Inventor: Kihong Kim, San Jose, CA (US)

(21) Appl. No.: 15/682,478

(22) Filed: Aug. 21, 2017

Related U.S. Application Data
(63) Continuation-in-part of application No. 15/488,291, filed on Apr. 14, 2017.
(60) Provisional application No. 62/377,840, filed on Aug. 22, 2016.
(60) Provisional application No. 62/323,140, filed on Apr. 15, 2016.

(51) Int. Cl. G02B 6/38; G02B 6/28; G02B 6/32; G02B 6/42; G02B 6/02

(52) U.S. Cl. CPC G02B 6/3861; G02B 6/4239; G02B 6/4202; G02B 6/02209; G02B 6/322; G02B 6/2848; G02B 6/3874

(57) ABSTRACT

Various techniques are provided for manufacturing an optical connector. In one example, a technique may include applying an optical adhesive to a first end of the optical fiber, translating the optical fiber towards a lens to at least partially adhere the end of the optical fiber to the lens by the optical adhesive, and suspending the lens from the optical fiber to align a center of gravity of the lens with an optical path of the optical fiber to maintain optical beam power loss below a power loss threshold. Additional methods, systems, and apparatus are also provided.

### CROSS-REFERENCE TO RELATED APPLICATIONS

This application claims the benefit of U.S. Provisional Patent Application No. 62/377,840 filed Aug. 22, 2016, which is incorporated by reference herein in its entirety.

This application is a continuation-in-part of U.S. patent application Ser. No. 15/488,291 filed Apr. 14, 2017, which claims the benefit of U.S. Provisional Patent Application No. 62/323,140 filed Apr. 15, 2016, all of which are incorporated by reference herein in their entirety.

### TECHNICAL FIELD

This disclosure relates generally to communications, and more specifically to electrical and optical interconnects for small and micro form factor devices.

### BACKGROUND

Small and micro form factor devices, such as mobile phones and tablets, offer limited modes of communication with other devices. It is common for such devices to have a single communications port configured to receive an electrical connector, as specified by one or more electronic communications standards. For example, many consumer electronics devices are limited to communicatively coupling with other devices, such as a personal computer or an audio/video system, through the available communications port using one or more communications standard, such as USB or HDMI. Adding communications ports for other standards or modes of communication may not be practical due to additional cost and the desire to maintain a small device size. As a result, other communications methods, such as optical communications, are not readily available in many small and micro form factor devices.

Additionally, equipment utilizing such other communications methods, including optical communications, may be difficult or cost intensive to manufacture. However, optical communications equipment requires precise alignment to minimize power and data loss. Precise alignment is difficult to achieve, especially in a cost effective manner. Accordingly, there is a need for improved systems and methods for manufacturing optical communications equipment.

### BRIEF DESCRIPTION OF THE DRAWINGS

FIG. 1 is a block diagram of an exemplary optical interconnection system in accordance with an embodiment of the present disclosure.

FIG. 2 is a block diagram illustrating optical coupling loss through misalignment of optical axes in accordance with an embodiment of the present disclosure.

FIG. 3A is an exemplary plot of a flat top beam profile in accordance with an embodiment of the present disclosure.

FIG. 3B is an exemplary plot of a Gaussian beam profile in accordance with an embodiment of the present disclosure.

FIG. 3C is a plot of a cross section of an exemplary beam profile mask in accordance with an embodiment of the present disclosure.

FIGS. 3D and 3E are plots of exemplary passing and failing beam profiles, respectively, in accordance with an embodiment of the present disclosure.

FIGS. 4A and 4B are block diagrams illustrating exemplary non-zero gap coupling in accordance with an embodiment of the present disclosure.

FIG. 5 is an exemplary plot of a transmitting aperture diameter vs. collimated Gaussian beam range in accordance with an embodiment of the present disclosure.

FIG. 6A illustrates an exemplary eye mask of an electrical specification in accordance with an embodiment of the present disclosure.

FIG. 6B is a block diagram illustrating an exemplary electrical pin interface in accordance with an embodiment of the present disclosure.

FIG. 7 is an exemplary state diagram for device discovery in accordance with an embodiment of the present disclosure.

FIGS. 8A and 8B are block diagrams illustrating exemplary misalignment tolerances in accordance with an embodiment of the present disclosure.

FIGS. 9A, 9B and 9C are block diagrams of an exemplary communications port and corresponding connector in accordance with an embodiment of the present disclosure.

FIGS. 10A, 10B and 10C are block diagram of an exemplary communications port and corresponding connector in accordance with an embodiment of the present disclosure.

FIG. 11 is a block diagram of an exemplary optical passive component to optical passive component coupling in accordance with an embodiment of the present disclosure.

FIG. 12 is a side view of a system for assembling optical components in accordance with an embodiment of the present disclosure.

FIGS. 13A and 13B illustrate various features of optical components in accordance with embodiments of the present disclosure.

FIG. 14A is a block diagram of a process for assembling an optical component in accordance with an embodiment of the present disclosure.

FIGS. 14B, 14C, 14D, and 14E, illustrate various operations of the process of FIG. 14A in accordance with embodiments of the present disclosure.

FIG. 15A illustrates an alignment of a lens to an optical fiber in accordance with an embodiment of the present disclosure.

FIG. 15B is a plot of a transmission losses associated with various lens alignments in accordance with an embodiment of the present disclosure.

Aspects of the disclosure and their advantages can be better understood with reference to the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

### DETAILED DESCRIPTION

In accordance with various embodiments of the present disclosure, systems and methods for interconnecting small and micro form factor devices through optical connections are provided. In one embodiment, a ferrule-less, non-contact, optical interconnect system and method is provided. The ferrule-less optical interconnect includes optical active components, including an optical beam source, such as a laser diode, for generating an optical beam meeting a minimum Gaussian beam profile, and a collimator for shaping a free space beam. The optical active components may also include a sink, such as a photodiode, and a condenser for focusing a free space beam. An optical connector includes optical passive components to receive the free space beam and shape the beam for propagation through an optical cable.

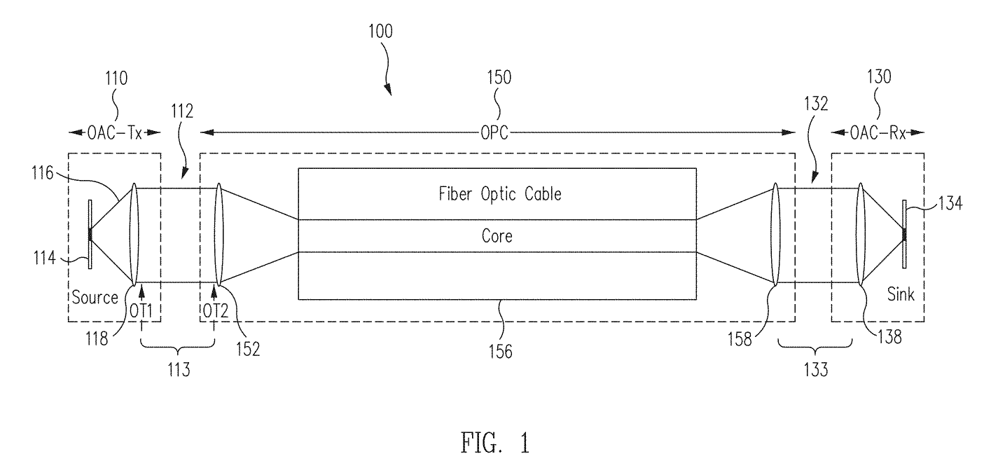

Referring to FIG. 1, an embodiment of an optical interconnect will be described. An optical interconnect system 100 includes an optical active components transmitter (OAC-Tx) 110, optical active component receiver (OAC-Rx) 130 and optical passive components (OPC) 150. In operation, the OAC-Tx 110 generates a free space beam 112 that travels through the gap 113 to a first end of the OPC 150. The OAC-Rx 130 generally uses a similar configuration for receiving a free space beam 132 formed by the OPC 150.

In one embodiment, the OAC-Tx 110 is disposed in a first host device, such as a mobile phone or tablet, and includes an optical source 114 that receives electrical signals from the host device and converts the electrical signals into an optical signal. In one embodiment, the optical source 114 includes a laser diode, such as a vertical cavity surface emitting diode (VCSEL), arranged to generate diverging optical beam 116. The OAC-Tx 110 further includes collimating lens 118 (collimator), which shapes the beam 116 to form collimated free space beam 112.

The OPC 150 includes a first lens 152, which receives the collimated free space beam 112 and focuses the beam for transmission through the core of fiber optic cable 156, and a second lens 158 for shaping the beam to form collimated free space beam 132 which travels across gap 133.

In one embodiment, the OAC-Rx 130 is disposed in a second host device, such as an A/V system, and includes an optical sink 134 that converts the received optical signal to electrical signals for processing by the second host device. In one embodiment, the OAC-Rx 130 includes a condenser lens 138 that focuses the collimated free space beam towards a photodiode (PD), which is arranged to sense the optical signal.

In an alternate embodiment, the OPC may include a conventional optical connector on one end, such as ferrule, for optically coupling with conventional optical devices. Further, each of the first host device and second host device may include one or more OAC-Tx and OAC-Rx components for bi-directional or multichannel communications. In various embodiments, the fiber optic cable may include a plurality of optical fibers and/or may be joined with electrical wires providing electronic communications in a hybrid arrangement. Although a single fiber optic cable is illustrated, the optical path between the OAC-Tx 110 and OAC-Rx 130 may include a plurality of OPCs coupled together.

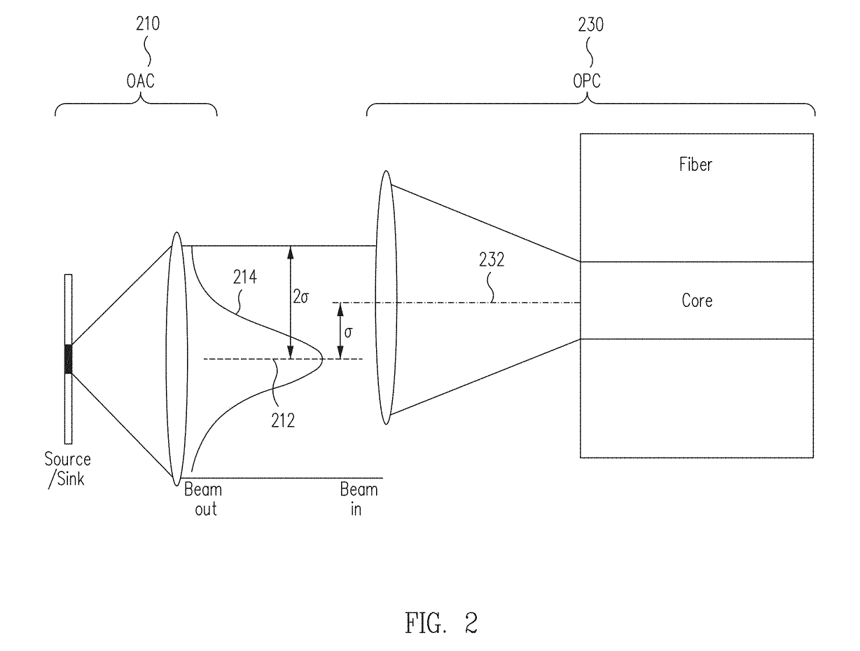

Referring to FIG. 2, alignment of the OAC and OPC will now be discussed with reference to the optical axis 212 of the OAC 210 and the optical axis 232 of the OPC 230. In various applications, coupling loss as illustrated might occur due to manufacturing or in field use (e.g., at a consumer's home). Misalignment of the optical axis 212 with the optical axis 232 can result in a loss of light energy and a disruption of communications. In the present embodiment, misalignment errors are attenuated, in part, by the selection and use of an optical beam profile suitable for use in the embodiment of FIGS. 1 and 2.

The exemplary optical beam profile disclosed herein will be understood with reference to the ray transfer matrix and use of the paraxial approximation of ray optics, including the paraxial wave equation with complex beam parameter. As illustrated, the collimated output beam 214 has a Gaussian power distribution profile, which minimizes coupling loss due to misalignment where the misalignment is by small amount relative to the overall beam diameter. In such cases, the misalignment affects mainly the tail parts of Gaussian distribution. In the illustrated embodiment, the loss is approximately 20% which is about 1 dB loss for 1σ misalignment.

Using a Gaussian beam profile has additional advantages including the availability of lasers with Gaussian beam profiles and the Gaussian waveform being a fundamental eigensolution for the paraxial wave equation used in some transceiver optical systems. However, many lasers produce beams that are non-ideal Gaussian. In one embodiment, a minimum Gaussian profile (MGP) is defined such that a non-Gaussian beam that satisfies the MGP can have reliable coupling power for an optical link as described herein.

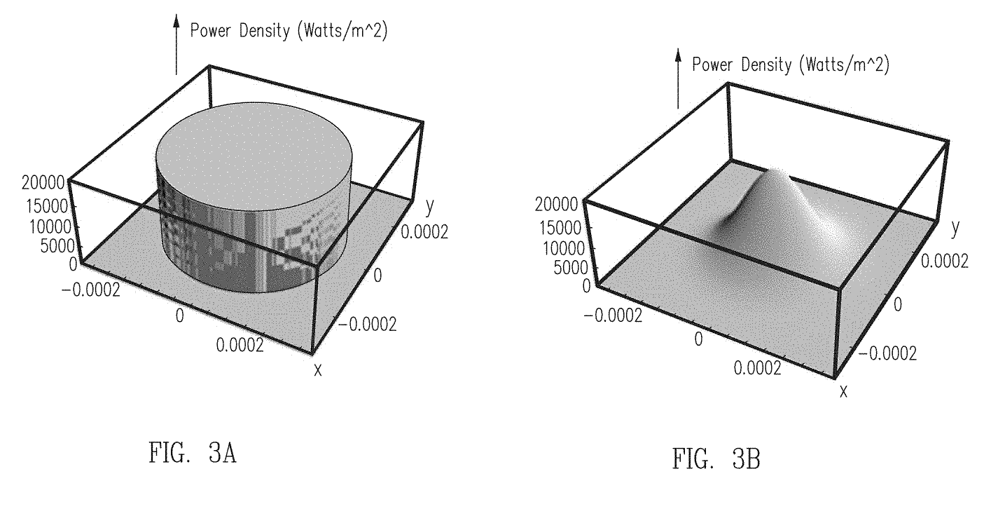

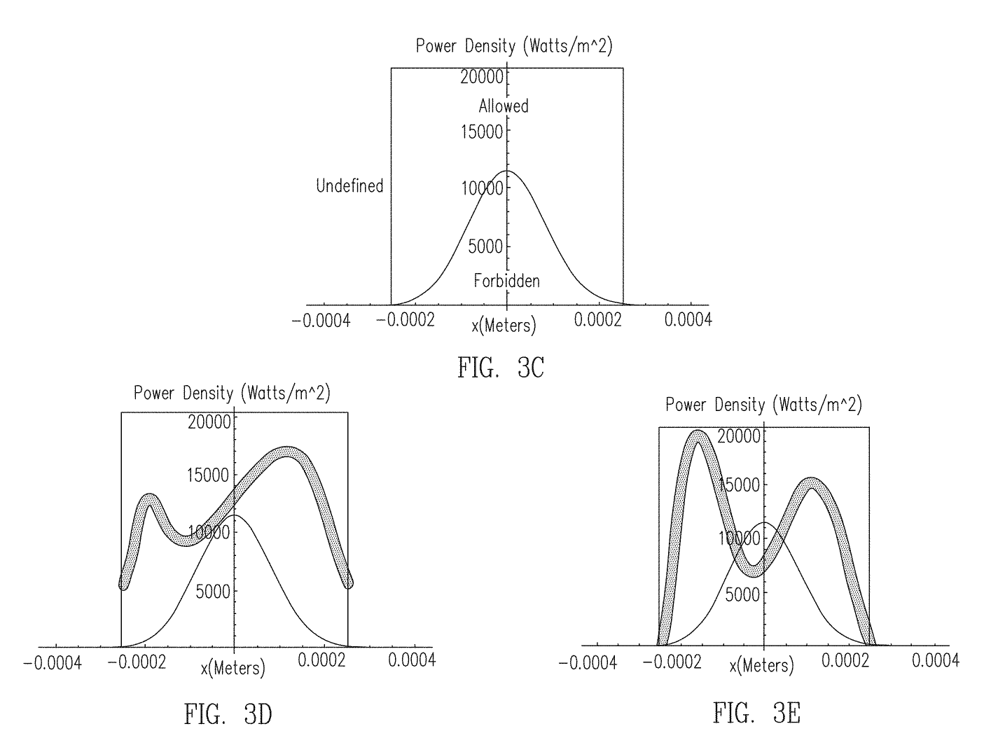

A beam profile mask is defined and explained below which includes details of Gaussian beam parameters in accordance with embodiments of the present disclosure. In one embodiment, the beam profile mask is comprised of a Flat Top Profile (FTP) as an upper bound and Minimum Gaussian Profile (MGP) for the lower bound. The Flat Top Profile is given in the following equation and is illustrated in the exemplary 3-dimensional plot of FIG. 3A:

FTP(x,y)=2.03718×10⁴×U(2.5×10⁻⁴−\sqrt{x²+y²})(Watts/m2)

where U(t) step function defined by,

$$U ( t ) = \{ \begin{matrix}1 if t > 0 \\ 0 if t < 0\end{matrix} \qquad ( 1 )$$

The Minimum Gaussian Profile is given by the following equation and is illustrated in the exemplary 3-dimensional plot of FIG. 3B:

MGP(x,y)=1.14592×10⁴×e^{{-7.2×10}^{⁷}^{×(x}^{²}^{+y}^{²}^{)}}(Watts/m2) (2)

FIG. 3C shows a cross section of the mask at y=0. Exemplary profiles that have passed and failed are shown in FIGS. 3D and 3E, respectively.

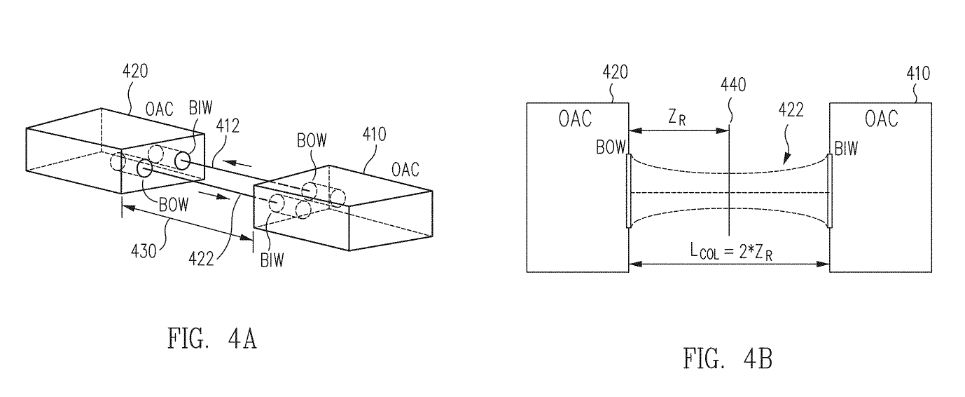

In various embodiments, non-zero gap (NZG) optical coupling between the optical active components and optical passive components is used. Non-zero gap (NZG) optical coupling will be described in further detail with reference to FIGS. 4A and 4B. By using NZG, burdens on consumer electronics manufactures to add optical receptacles and invest in precision equipment for proper alignment of conventional optical interconnects is alleviated.

FIG. 4A is an embodiment of a direct, free space, bi-directional communication channel in accordance with the present disclosure. As illustrated, each channel, 412 and 422, is implemented using a free space Gaussian beam (ideal or non-ideal Gaussian beam as described herein) from transmitter to receiver between two chips, 410 and 420, respectively. In this embodiment, both chips are sufficient aligned physically with each other and the beams do not substantially diverge or converge. The non-zero gap 430 of the present embodiment allows spacing between the beam output window (BOW) and the beam input window (BIW) when the light signal is traveling off-chip (i.e. off-OAC).

In practice, a spatially coherent Gaussian beam diverges, and ideal collimation is not possible. Referring to FIG. 4B, in one embodiment the beam is substantially collimated to provide minimal focusing such that the beam waist 440 is located in the middle of L_{col}, and such that beam diameter at BOW and BIW are both increased from the diameter of the beam waist. In one embodiment, the beam diameter at BOW and BIW are both increased by the square root of the beam waist radius. In the illustrated embodiment the collimation length, L_{col}, is related to the Rayleigh range—the distance from the waist 440 of the beam to the point at which the area of the cross section of the beam is doubled. L_{col} may be defined for any OAC such that the beam waist is located in the middle of L_{col} such that beam diameter at BOW and BIW are both greater than the beam waist diameter and increasing from the beam waist. Here, the Gaussian beam output from the transmitter of OAC 420 is collimated up to minimum 100 mm such that L_{col}≧100 mm.

In one embodiment, optical beam characteristics are based on paraxial approximation where the ray angle (θ) from an axial (z-axis) direction holds the following approximation, tan θ≅θ. Beam parameters and related definitions can be found in industry standard, ISO11146-2, which describes laser beam characteristics using second order moments of the Wigner distribution, and is incorporated by reference herein in its entirety. Theoretically, this can be used on any optical beam, regardless of where it is Gaussian or non-Gaussian, fully coherence or partially coherence, single mode or multiple transverse mode.

Exemplary beam parameters for the illustrated embodiment are set forth below:

i. D_{beam} (Beam waist: D4σ)=4σ,

where σ is defined at z₀ by

$$σ = \sqrt{\frac{{\int }_{- ∞}^{∞} {\int }_{- ∞}^{∞} {( x - {x}_{0} )}^{2} I ( x , y ) dxdy}{{\int }_{- ∞}^{∞} {\int }_{- ∞}^{∞} I ( x , y ) dxdy}} \qquad ( A1 )$$

and I(x,y) is optical power density at beam waist location, z₀, of beam with ε (Beam Ellipticity≡d_{σ(short}_{_}ₐₓᵢₛ₎/d_{σ(long}_{_}ₐₓᵢₛ₎) being less than 0.87 (see ANSI 11146-1)

ii. ⊖_{f} (Divergence Full Angle)=2×θₕ,

where θₕ is half angle of beam divergence (subtending angle from origin to 2σ of far field Gaussian profile)

iii. BPP (Beam parameter product)=w₀×θₕ (A2)

iv. M² (Beam propagation ratio)=π×BPP/λ

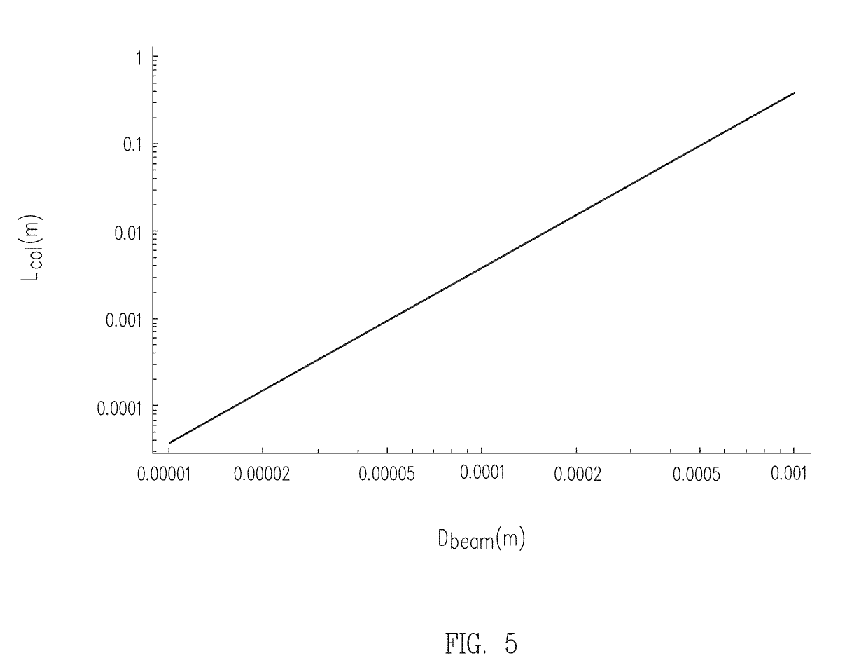

The optical interface in the connector is specified by the Beam Parameter Product (BPP) defined by

$$BPP ≡ \frac{{D}_{beam @ OT 1} \times {θ}_{max}}{4}$$

where D_{beam@OT1} is the beam diameter of 4σ, θₘₐₓ is beam divergence at BOW (beam output window) of the optical transmitter assuming the beam is stigmatic, and OT1 is a first optical test point (see, e.g., FIG. 1). For example, diffraction limited Beam Parameter Product, BPPg, can be achieved for ideal Gaussian Beam for λ=850 nm which is approximately BPPg=0.271 mm·mrad. FIG. 5 shows an exemplary plot for the transmitting aperture diameter (D_{beam}) vs. the collimated Gaussian beam range (L_{col}) for a Gaussian beam of the same wavelength.

The illustrated embodiment allows beam distortions from OT1 signal due to ULPI (unintentional light path impairment) such as misalignment, reflection, bending, thermal distortion of optical media including air, dust etc. Thus, beam parameters in the illustrated system at optical test point 2 (OT2, the optical location at BIW) allows the increase of BPP (as also described below in terms of M² value). The tables, below, summarize an exemplary specification for related parameters at OT1 (BOW) and OT2 (BIW):

Optical beam specification at OT1

| | Min. | Typ. | Max. |
|---|---|---|---|
| D_{beam@oT1}(um) | 450 | 500 | 550 |
| θₘₐₓ(mRad/°) | | 10/0.57 | 22/1.26 |
| BPP (mm · mrad) | BPPg@850 nm | 1.25 | 3.0 |

Optical beam specification at OT2

| | Min. | Typ. | Max. |
|---|---|---|---|
| D_{beam@oT2}(um) | 450 | 500 | 550 |
| θₘₐₓ(mRad/°) | | 30/0.57 | 66/1.26 |
| BPP (mm · mrad) | BPPg@850 nm | 3.75 | 9.1 |

The present embodiment allows maximum M² increase (MSI) through the light path through which the signal beam travels from OT1 to OT2 via any OPC (optical passive component) or ULPI (unintentional light path impairments). Thus, the light path in the present embodiment meets the following MSI specification: minimum MSI=1.0 (0 dB); maximum MSI=3.0 (4.7 dB).

Exemplary total signal power for OT1 and OT2 in the present embodiment are set forth in the following table, in which the total power of a collimated beam is defined within the circle having the diameter of D_{beam@oT1} and D_{beam@oT2}, respectively:

| | Min. | Typ. | Max. |
|---|---|---|---|
| OT1 (ouput) | −3 dBm | −2 dBm | 1 dBm |
| OT2 (input) | −9 dBm | −3 dBm | 0 dBm |

It will be appreciated by those having skill in the art that this optical signal specification provides advantages in link performance such as BER or analog noise when collimating and focusing correctly.

One goal of the present embodiment is to make use of commonly accessible electrical interfaces that are commonly available for use on small devices and accessible by existing electrical Serializer/Deserializer (SERDES) components used in high speed communications, such as using existing USB and/or HDMI interface components through minimal passive (or non-) modification by external circuit introduction.

Exemplary electrical specifications for the illustrated embodiment are set forth below.

| | |
|---|---|
| Power ground rail | 1.8 V TX/RX interface |
| Bandwidth | f_{MFP}(bps) capabilities = 10 G; 12.5 |
| | G; 25 G |
| T_{bit} | T_{bit} ≡ 1/f_{MFP}: 100 ps; 80 ps; 40 ps |
| TX differential input at | 600 mVpp/1000 mVpp |
| T1: min/max | |
| Rx differential output at | 300 mVpp/500 mVpp |
| T2: min/max | |
| Eye-width (Jitter and | Tx input jitter allowed : Jt > 0.4 UI |
| skew) | Rx output jitter max: Jt < 0.5 UI |
| | Infra pair skew generation at Rx: |
| | <0.05 UI |

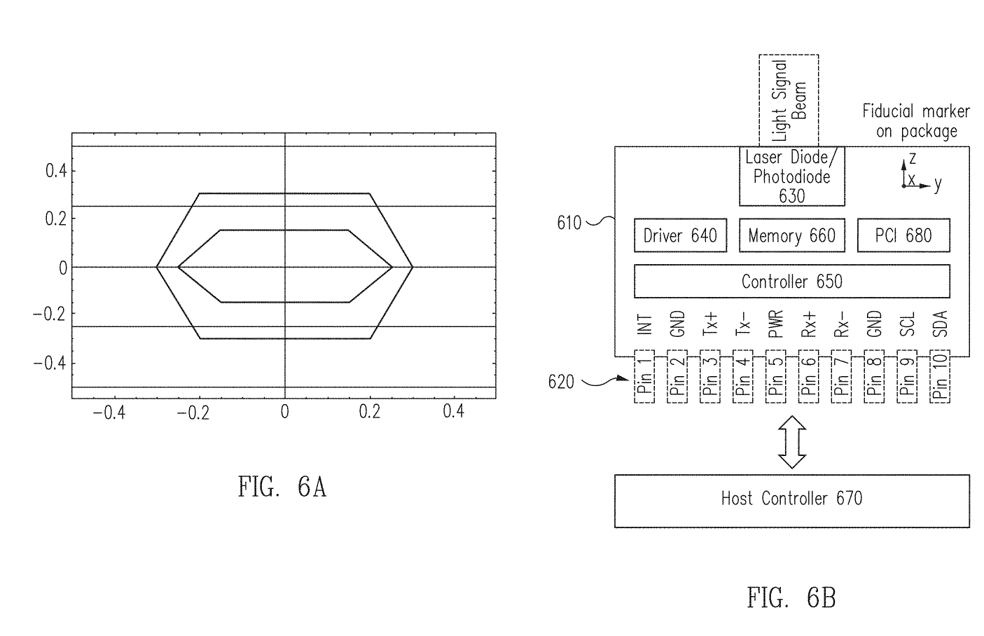

These specifications may not be ideal to electrically drive (or be driven by) a cable connector in many applications, but are sufficient to drive board trace of minimal 10 cm in tested embodiments. FIG. 6A illustrates an eye mask of the exemplary electrical specification.

FIG. 6B illustrates an exemplary semiconductor package 610 and electrical I/O pins 620. In one embodiment, I²C is used as a control interface to control local micro form factor photonics. The mechanical assembly may include a fiducial marker for reference in aligning the beam path. Depending on the implementation, the package 610 may function as a transmitter, receiver or transceiver and include one or more laser diodes/photo diodes 630, a driver 640, controller 650, memory 660 (which may be implemented as volatile or non-volatile memory, including a non-transitory computer readable medium) and other circuitry and logic, as appropriate. The device is generally controlled by an I²C interface for set-up, loss of signal (LOS), hot-plug detect, device discovery, contention resolution and other operational features. These and other operations may be implemented through a combination of dedicated circuitry and components and program logic stored in memory 660 for implementation by controller 650. In addition to two I²C pins, INT pin is provided to interrupt any process when it requires by local controller 650 or a remote processor, such as host controller 670.

In one embodiment, the controller 650 monitors loss of signal and whether the optical receiver receives proper level of optical power to avoid performance targets of bit error rate or analog signal to noise ratio. The loss of signal may also be tracked for safety to avoid the optical beam straying around non-defined optical path such that human eyes can be exposed or other safety concerns avoided. Optical power level is recommended to be set at Pₗₒₛ (of −12 dBm for example) at Rx through I²C.

A hot-plug of an optical link may be detected optically by monitoring optical power as long as both Tx and Rx are electrically powered through beacon light coming out from Tx and sensed at Rx with optical power of P_{bcn}=Pₗₒₛ−3 (informative). Therefore, normal operation of an optical link may discriminate whether the optical input is a relative drop due to loss of service or absolute changes of all optical input power including signal power level compared to the setting values described above.

In one embodiment, device discovery is achieved through a photon-copper interworking (PCI) block 680, which emulates auxiliary interface functions such as device discovery or other upper layer protocols. There are certain physical layer issues to translate the analog electrical signal into optical domain. The present embodiment defines a new functional block in-between electrical-to-optical interface to fulfill the link set-up process. The PCI block 680 is implemented to translate such functions in which case the information of electrical connect (or disconnect) is transferred to the optical domain, and vice versa. Although in the optical domain there are many possible ways to transmit and receive the bi-directional information on one optical fiber, the media should be transferred in-between optical and electrical. Thus a simplified processing controller for such purpose is recommended to implement such PCI with two wire communications in between.

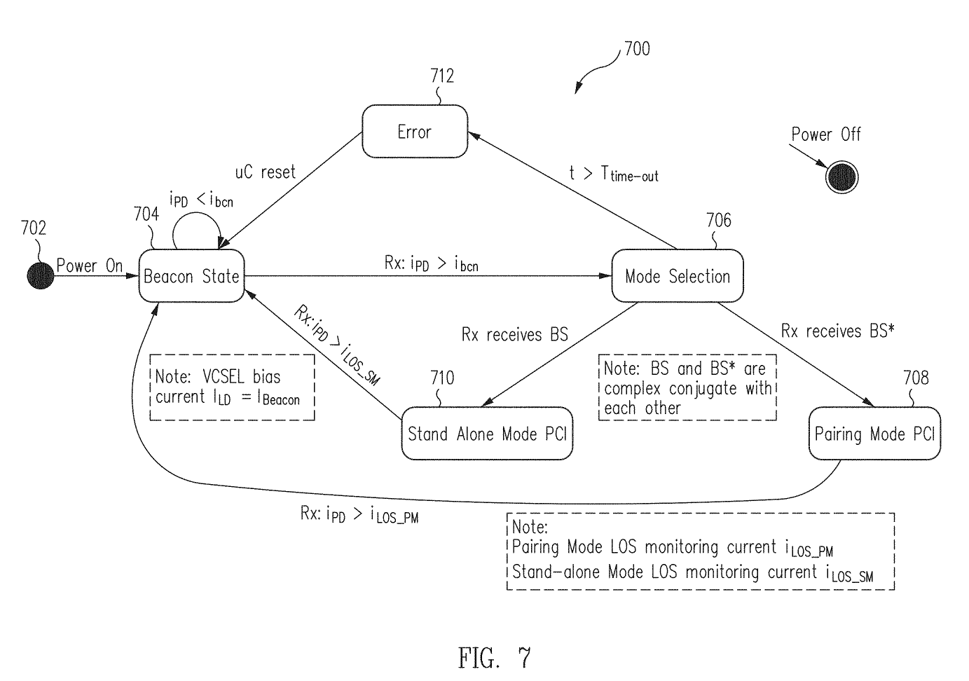

An embodiment of a beacon to PCI state diagram 700 is illustrated in FIG. 7. At 702, the optical components are powered on and the beacon state is detected in block 704. Control remains at block 704 while the current measured at photodiode, i_{PD}, is less than a beacon current threshold, i_{bcn}. If the device receives an optical signal such that i_{PD}>i_{bcn} then control is passed to the mode selection block 706. In standalone mode PCI 710, a loss of service process monitors current at the photodiode and compares the measured current to a standalone mode LOS threshold, i_{LOS}_{_}_{SM}. Control passes to beacon state 704 when i_{PD}>i_{LOS}_{_}_{SM}. In the pairing mode PCI block 708, a loss of service process monitors current at the photodiode and compares the measured current to a pairing mode LOS threshold, i_{LOS}_{_}_{PM}. Control passes back to beacon state 704 when i_{PD}>i_{LOS}_{_}_{PM}. If mode selection 706 times out, control passes to error block 712 which sends resets signal and control passes back to beacon state 704.

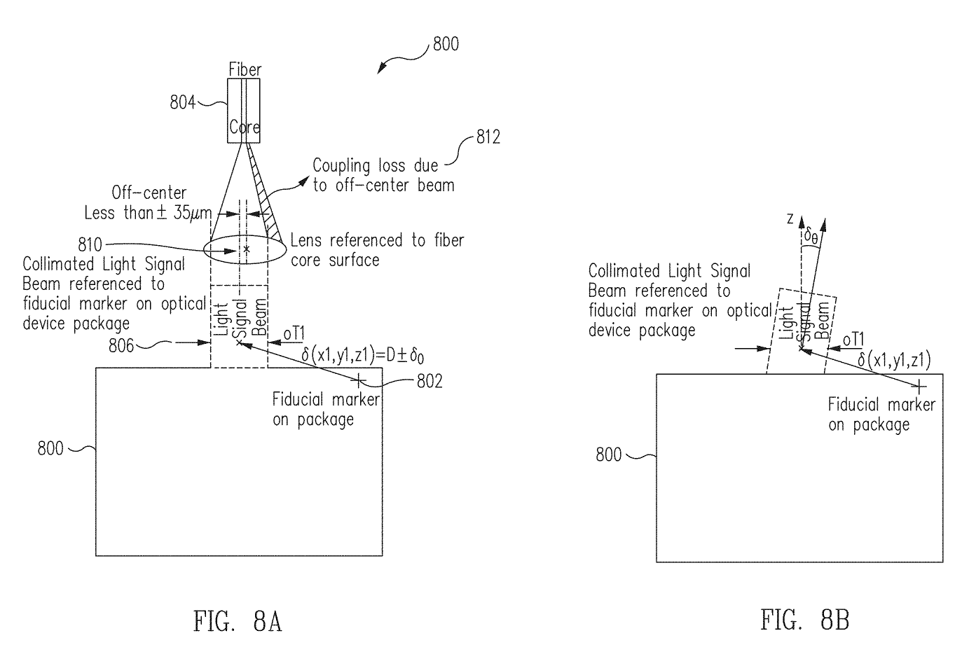

Referring to FIGS. 8A and 8B, misalignment errors will be discussed in further detail. FIG. 8A illustrates an exemplary optical device package 800 with a reference point 802 for aligning the light signal beam with the core of an optical fiber 804. In one embodiment, the maximum displacement target between the core and the optical device package is δ₀=35 μm for reliable communications. As illustrated, a misalignment 810 by 35 μm or less would yield coupling loss 812 that still allows for reliable communications performance in accordance with the specifications herein. FIG. 8B illustrates misalignment due to angle of displacement. In one embodiment, the maximum angular displacement with reference to the desired beam path is δ_{θ}=0.35 mrad.

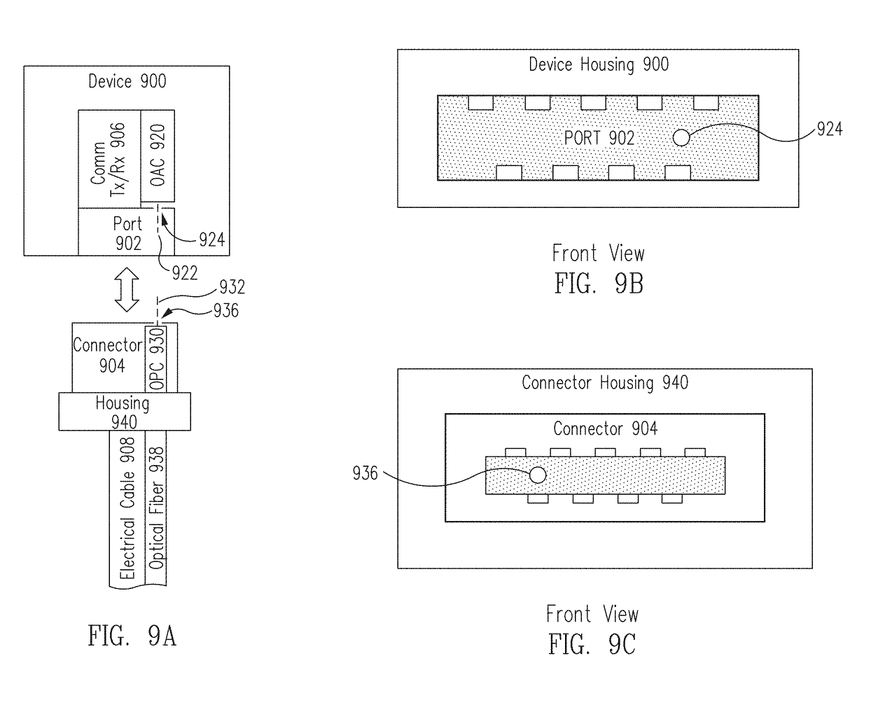

Referring to FIGS. 9A, 9B and 9C, an interconnect system implementing the present disclosure will now be described. A device 900, such as a mobile telephone, includes a communications port 902 for receiving a corresponding connector 904. The port 902 is controlled by communications transceiver (Tx/Rx) components 906, which facilitates communications between the device 900 and another device (not shown) through the communications cable 908. In various embodiments, Tx/Rx 906, port 902, connector 904 and cable 908 are configured to provide communications in accordance with a digital or analog electrical communications standard, such as HDMI or USB.

For many devices, it is desirable to maintain a small form factor and adding additional ports is not a desirable option. In the illustrated embodiment, optical active components (OAC) 920 are provided, including an optical source that generates a beam along beam path 924. In other embodiment, the OAC 920 may include an optical sink that receive a beam along beam path 924. To facilitate the optical communications, the port 902 includes a hole 924 sufficient to allow the beam to travel from the OAC 920, through the hole and into the port 902 along beam path 922. The connector 904 includes corresponding optical passive components (OPC) 930 arranged such that optical path 932 is aligned with optical path 922 when the connector 904 is inserted and communicably coupled with the port 902 for electrical communications.

Referring to FIGS. 9B and 9C, the holes 924 and 936 may be positioned at an available location in the port 902 and on connector 904, respectively. The positions of the holes will vary depending on the arrangement of connector and availability of free space for the optical beam path. The alignment of the connector 904 in port 902 allows the holes 924 and 936 to substantially align for optical communications allowing for non-zero gap optical coupling. The OAC 920 can be positioned within the circuitry of the device 900 and the OPC 930 can be positioned within the connector 904 and/or connector housing 940 and is coupled to an optical fiber 938, which is combined with electrical cable 908 to form a hybrid electrical/optical cable and connector.

Referring to FIG. 11, an exemplary embodiment of OPC to OPC coupling will now be described. In various embodiments, the OPC 930 may be optically coupled to optical passive components, such as optical passive components 1130. In the illustrated embodiment, the optical passive components 1130 are housed in a hybrid electrical/optical cable and connector including an electrical connector 1104, adapted to receive connector 904 to form an electrical coupling, an electrical cable 1108, a housing 1140 and optical fiber 1138. This arrangement can be used, for example, to connect two or more optical cables in series.

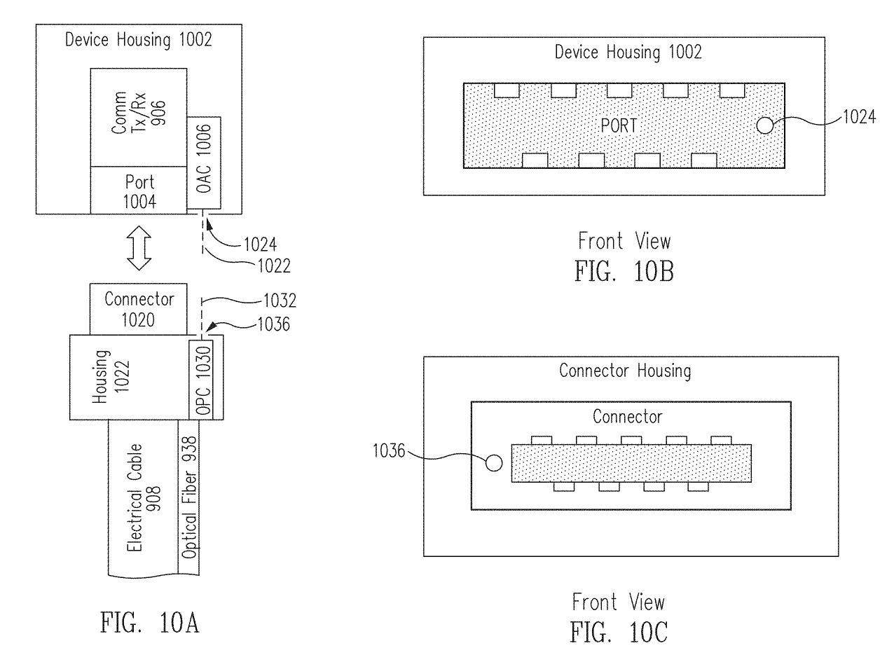

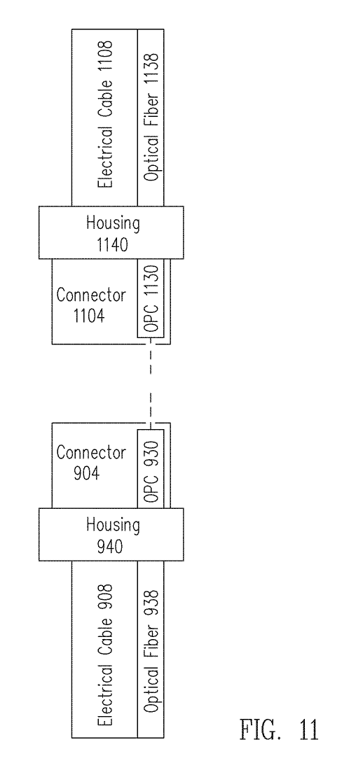

Some interconnect technologies don't provide sufficient open space in the port allowing for optical communications. In one embodiment, the electrical components may be removed from the connector to open up free space in a dedicated optical interconnect cable. In another embodiment, the beam path may be moved to the housing adjacent to the port. Referring to FIGS. 10A, 10B and 10C, a hole 1024 is provided in device housing 1002, adjacent to the port 1004. OAC 1006 is aligned adjacent to the hole 1024 allowing the beam to travel along free space beam path 1022. When the connector 1020 is inserted into the port 1004, the connector housing 1022 is positing against or adjacent to the device housing 1002. The connector housing 1022 includes OPC 1030 for transmitting or receiving an optical beam through a hole 1036 in the connector housing 1022, along a beam path 1032, which is substantially aligned with optical path 1022 for optical communications.

The optical connectors may be fabricated according to various techniques described herein. Accurate alignment of optical fibers to lenses can minimize power loss when transmitting optical data. In certain such techniques, lenses may be aligned to optical fibers in accurately and cost effectively using the techniques described.

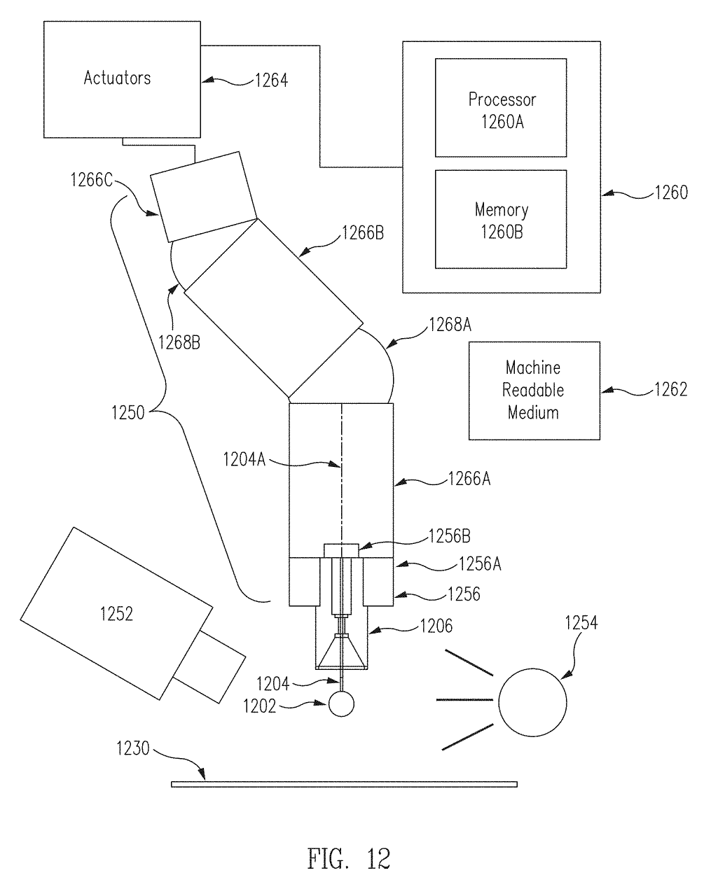

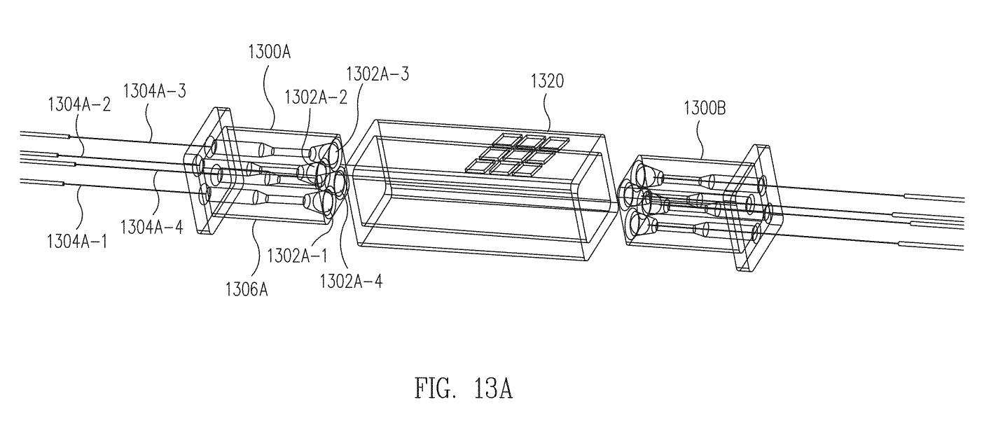

FIG. 12 is a side view of a system for assembling optical components in accordance with an embodiment of the present disclosure. The system shown in FIG. 12 includes a base 1230, a manufacturing fixture 1250 that is shown to hold a sleeve body 1206, an optical fiber 1204, and a lens 1202, a sensor 1252, an ultraviolet (UV) source 1254, actuators 1264, controller 1260, and machine-readable medium 1262.

Base 1230 may be configured to receive one or more lenses 1202 and provide such lenses 1202 to manufacturing fixture 1250. The manufacturing fixture 1250 may, in various embodiments, be a robot arm, a portion of a pick and place machine, and/or performed manually (e.g., by hand). In other embodiments, the techniques described herein for assembling optical components can be spread among a plurality of apparatuses and/or workers. For example, each step and/or certain combinations of steps described herein can be performed by one machine and, after such steps are performed, a second machine can then receive the part and perform further operations.

As shown in FIG. 12, the manufacturing fixture 1250 includes arm portions 1266A, 1266B, and 1266C and an end effector 1256. Arm portion 1266C may be a fixed base and arm portions 1266A and 1266B may be configured to move relative to the arm portion 1266C via joints 1268A and 1268B. Joints 1268A and 1268B allow arm portions 1266A and 1266B to move in one to six degrees of freedom via rotation and/or translation.

Arm portion 1266A is coupled to end effector 1256. End effector 1256 can be configured to hold sleeve body 1206 and/or optical fiber 1204. In certain embodiments, the end effector 1256 can include multiple portions, such as sleeve fixture 1256A and fiber fixture 1256B. Sleeve fixture 1256A may be configured to receive sleeve body 1206 while fiber fixture 1256B may be configured to receive optical fiber 1204. Other embodiments can include two or more end effectors, each end effector configured to receive one of sleeve body 1206 or optical fiber 1204. Each such embodiment may allow for optical fiber 1204 to move independently of sleeve body 1206. For example, sleeve fixture 1256A may hold sleeve 1206 while fiber fixture 1256B moves optical fiber 1204, or vice versa. As such, optical fiber 1204 can be inserted and/or retracted through a channel of sleeve body 1206.

Thus, sleeve fixture 1256A may receive sleeve body 1206 and fiber fixture 1256B may move (e.g., translate) optical fiber 1204 relative to sleeve body 1206 (e.g., translate optical fiber 1204 downward through a channel of sleeve body 1206 towards lens 1202). Upon contact of optical fiber 1204 with lens 1202, optical adhesive previously applied to an end of optical fiber 1204 (e.g., a first end of optical fiber 1204) may partially adhere lens 1202 to optical fiber 1204 (e.g., allow for lens 1202 to be coupled to optical fiber 1204 while still allowing for an amount of movement of lens 1202 relative to optical fiber 1204). The other portion of end effector 1256 may then raise optical fiber 1204 to suspend lens 1202 from optical fiber 1204. Suspending as such may allow for alignment of a center of gravity of the lens 1202 with an optical path of optical fiber 1204.

In certain embodiments, optical fiber 1204 may be trended into the channel of sleeve body 1206 before sleeve body 1206 is received by end effector 1256. In other embodiments, manufacturing fixture 1250 and/or fiber fixture 1256B can provide optical fiber 1204 to the channel of sleeve body 1206 (e.g., when sleeve body 1206 is received by sleeve fixture 1256A). In certain such embodiments, sleeve fixture 1256A may receive sleeve body 1206 and fiber fixture 1256B can provide optical fiber 1204 to sleeve body 1206 (e.g., optical fiber 1204 can be threaded into sleeve body 1206). In such embodiments, manufacturing fixture 1250 may include a volume that stores optical fiber 1204 to be provided to sleeve body 1206. Other examples can store optical fiber 1204 in other fixtures, such as an optical fiber corral.

Movement of end effector 1256, joints 1268A and/or 1268B, and/or arm portions 1266A-C may be controlled by one or more actuators 1264. Actuators 1264 can be one or more electric motors, hydraulic motors, mechanical linkages, manually operated linkages, belts, gears, other power transmission devices, and/or other components that allow for movement of the manufacturing fixture 1250. Actuators 1264 may be concentrated in one area, or may be distributed across various different portions of manufacturing fixture 1250 (e.g., within arm joint 1268A or 1268B and/or within arm portions 1266A, 1266B, and 1266C of manufacturing fixture 1250). In embodiments where techniques are performed via different stations, one or more such stations may have one or more separate actuators.

Sensor 1252 may detect when the center of gravity of the lens 1202 is aligned with the optical path of optical fiber 1204. Sensor 1252 may be, for example, a visual sensor (e.g., a camera), an electromagnetic wave emitting sensor such as a radar or laser, a thermal sensor, and/or other type of sensor that may determine when lens 1202 is aligned with optical fiber 1204.

UV source 1254 may be configured to cure adhesives applied to lens 1202, optical fiber 1204, and/or sleeve body 1206. The UV source 1254 can provide UV light to cure such adhesives. In other embodiments, curing of the adhesives may be performed through other techniques such as with a heat lamp and/or through drying out of adhesives.

The components of the system illustrated in FIG. 12 may be controlled by controller 1260. Controller 1260 may include one or more processors 1260A and one or more non-transitory memory 1260B. Processor 1260A may be a single-core or multi-core processor or microprocessor, a microcontroller, a logic device, a signal processing device, and/or another such processing device. The memory and/or machine readable medium 1262 can include instructions to perform techniques described herein (e.g., software, firmware, or other instructions). Memory 1260B may be a magnetic or solid state hard drive or other storage medium. Examples of such memories include RAM (Random Access Memory), ROM (Read-Only Memory), EEPROM (Electrically-Erasable Read-Only Memory), flash memory, or other types of memory. Machine readable medium 1262 may be, for example, a CD-ROM, DVD, USB, removable hard drive, downloadable instructions, and/or other such medium that may store instructions. Machine readable medium 1262 can be inserted and/or otherwise provided to controller 1260 and controller 1260 can provide instructions to perform techniques disclosed herein. Controller 1260 and/or its associated operations may be implemented as a single device or multiple devices (e.g., communicatively linked through wired or wireless connections) to collectively constitute the controller 1260. Controller 1260 may also be communicatively linked with any of the other components shown in FIG. 12 or described herein and may be configured to direct performance of the techniques or any portion thereof of the techniques described herein.

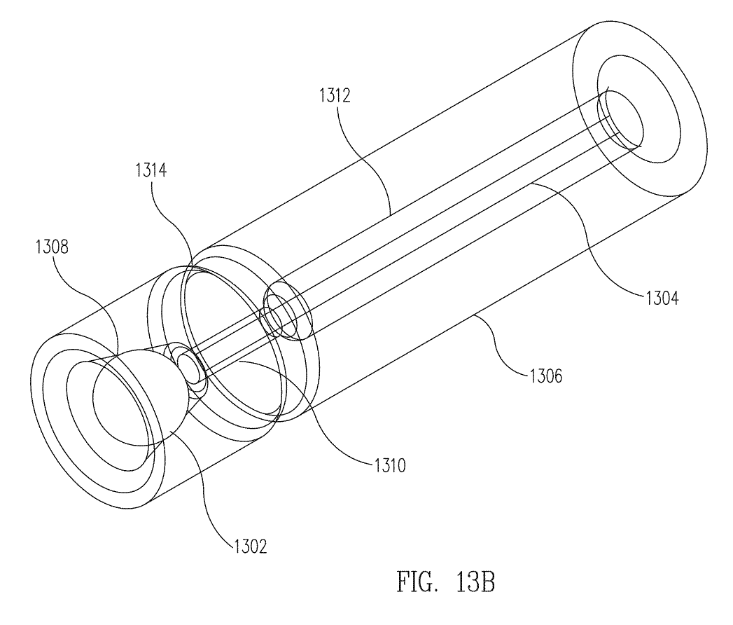

FIGS. 13A and 13B illustrate various features of optical components in accordance with embodiments of the present disclosure. FIG. 13A illustrates plug connectors 1300A and 1300B and receptacle 1320. In FIG. 13A, receptacle 1320 is configured to receive both plug connectors 1300A and 1300B and control distance between plug connectors 1300A and 1300B when plug connectors 1300A and 1300B are inserted into receptacle 1320. Other embodiments may not include receptacle 1320 and, instead, one of plug connectors 1300A or 1300B may be a receptacle configured to receive a mating connector such as a plug connector instead. The plug connectors 1300A and 1300B may include one or more features configured to align the connector to a mating connector and/or a receptacle.

Plug connectors 1300A and 1300B may include one or more lenses (e.g., lenses 1302A-1 through 1302A-4), each lens coupled to a first end of an optical fiber (e.g., optical fibers 1304A-1 through 1304A-4, respectively). Each plug connector can include one or more channels and/or recesses that may receive a lens and/or an optical fiber. In certain embodiments, one or more of the optical fibers can be disposed in additional components (e.g., within another portion of the connectors, within wires, and/or within another such component).

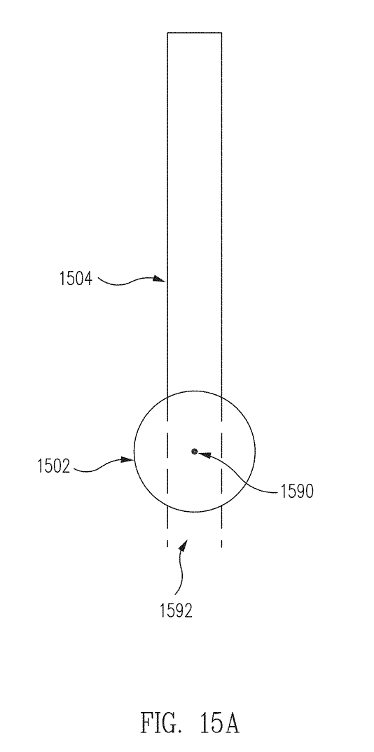

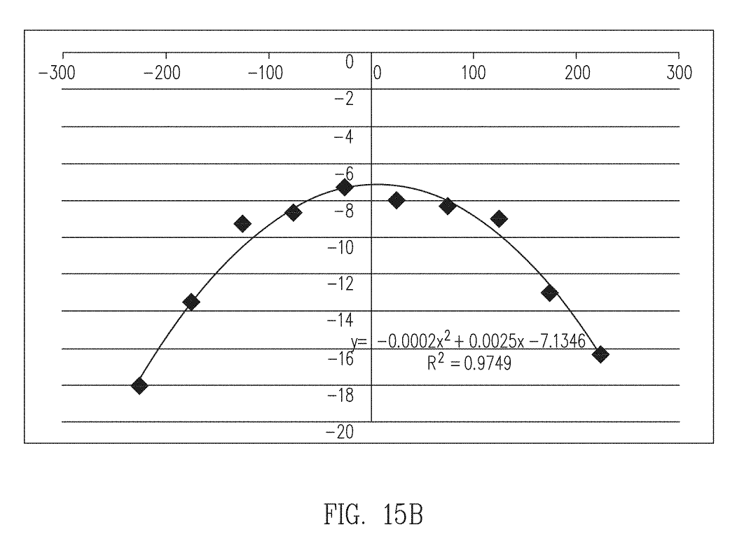

Each of the lenses 1302A-1 through 1302A-4 can be aligned to each respective optical fiber 1304A-1 through 1304A-4 to maintain optical beam power loss below a power loss threshold. As such, a center of gravity of each of the lenses may be aligned with an optical path of the respective optical fiber. Such alignment is illustrated in further detail in FIG. 15A.

FIG. 13B illustrates various features of plug connectors in further detail. FIG. 13B illustrates a sleeve body 1306. Sleeve body 1306 includes recess 1308, a channel first portion 1310, and a channel second portion 1312. In certain embodiments, sleeve body 1306 may be configured to be inserted into a connector while, in other embodiments, sleeve body 1306 may be the connector itself. Sleeve body 1306 may be formed from any appropriate material for containing lens 1302 and optical fiber 1304 (e.g., composites, plastics, metals, and/or other such materials). In embodiments where sleeve body 1306 is inserted into a connector that includes a plurality of lenses, a plurality of sleeve bodies containing such lens may be inserted into the connector.

Recess 1308 may be connected to channel first portion 1310 and channel first portion 1310 may be connected to channel second portion 1312. Recess 1308 may be configured to receive lens 1302. Recess 1308 can include features that align lens 1302 within recess 1308 and, thus, align lens 1302 to certain features of sleeve body 1306 and/or the connector that sleeve body 1306 is disposed within. For example, the connector may include one or more pins and recess 1306 may be substantially conical and/or include a taper that aligns lens 1302 to the one or more pins within a tolerance. Other embodiments of the recess can include curved surfaces and/or other features that are configured to align lens 1302.

For example, lens 1302 may be a ball lens, a spherical lens, a cylindrical lens, or a cone-shaped lens. The recess 1308 may then include a tapered surface and, when recess 1308 receives lens 1302, such a tapered surface can align lens 1302 within recess 1308.

Channel first portion 1310 and channel second portion 1312 may be configured to receive optical fiber 1304. Optical fiber 1304 may be a fiber of a first optical cross-sectional area. Channel first portion 1310 may include a first channel cross-sectional area larger than the first optical cross-sectional area and channel second portion 1312 may include a second channel cross-sectional area larger than the first channel cross-sectional area and the first optical cross-sectional area. As channel first portion 1310 is disposed closer to recess 1308 than channel second portion 1312, the smaller first cross-sectional area may aid in alignment of the lens 1302 and/or optical fiber 1304 relative to sleeve body 1308. Additionally, the smaller cross-sectional area of channel first portion 1310 may be configured to hold the portion of optical fiber 1304 close to lens 1302 substantially straight. Having the portion of optical fiber 1304 that is close to lens 1302 substantially straight may allow for optical transmission from optical fiber 1304 to lens 1302 with minimal power loss. The larger cross-sectional area of channel second portion 1312 may then allow for the portion of optical fiber 1304 farther from lens 1302 to flex to prevent damage to optical fiber 1304.

In certain examples lens 1302 may be adhered to optical fiber 1304 via an optical adhesive. The optical adhesive may be a single part or multi-part adhesive. The optical adhesive may include an index of refraction substantially similar (e.g., within 50%) to an index of refraction of optical fiber 1304 or lens 1302. In certain such embodiments, the lens and the optical fiber 1304 may be formed from the same material and/or may be formed from materials with substantially similar indices of refraction.

In certain embodiments, the lens 1302 and the optical fiber 1304 can be sized according to certain ratios. For example, in embodiments where lens 1302 is a cylinder or ball shaped lens and optical fiber includes a substantially circular cross-section, a diameter of lens 1302 may be at least four times larger than the cross-sectional diameter of optical fiber 1304. Additionally, in certain embodiments, lens 1302 may be a lens with a diameter of 2 millimeters or less. Also, an index of refraction of lens 1302, optical fiber 1304, and/or the lens adhesive may be 3 or less.

Additionally, lens 1302 may be adhered to recess 1308 via a lens adhesive. The lens adhesive may be a single part or multi-part adhesive. In certain embodiments, the lens adhesive may include an index of refraction substantially similar to an index of refraction of lens 1302, but other embodiments may have the index of refraction of the lens adhesive be dissimilar to the index of refraction of lens 1302 to prevent the lens adhesive from altering the optical properties of lens 1302.

Sleeve body 1306 may additionally include notch 1314. In embodiments of sleeve body 1306 where sleeve body 1306 is configure to be inserted into a connector, notch 1314 can allow for deformation of sleeve body 1306 to ease insertion of sleeve body 1306 into the connector.

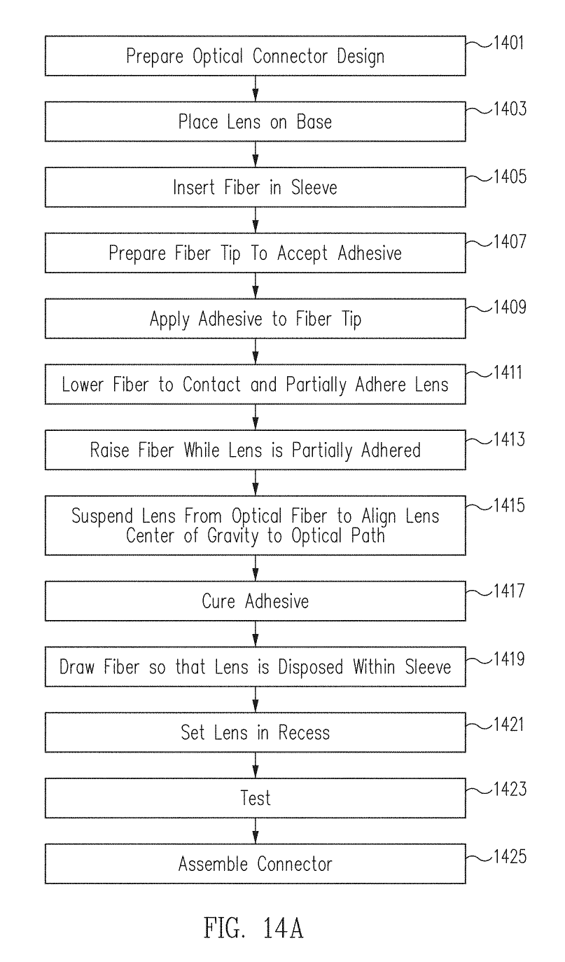

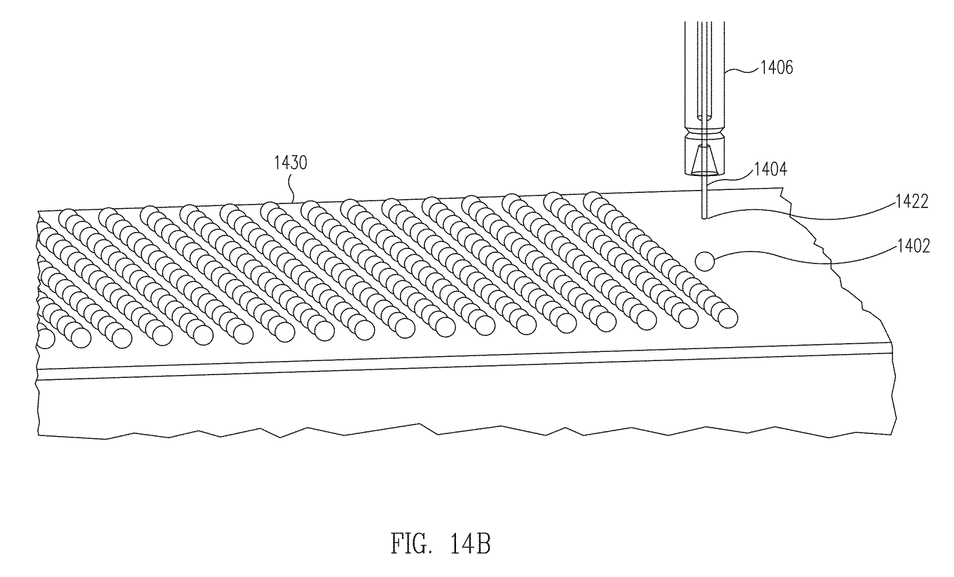

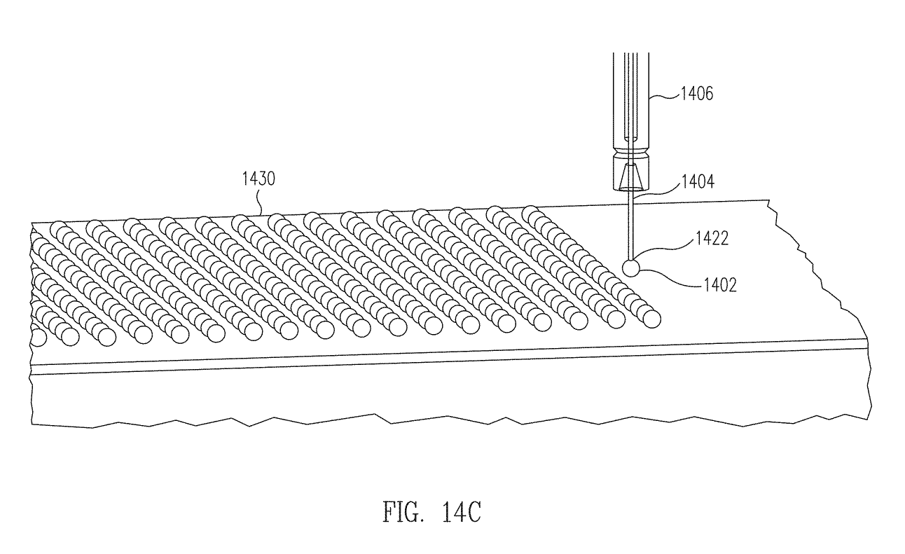

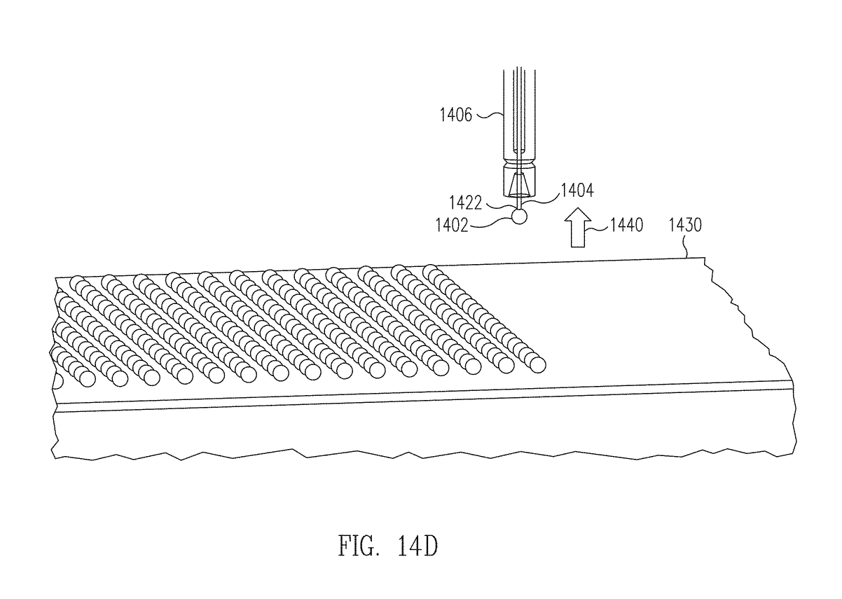

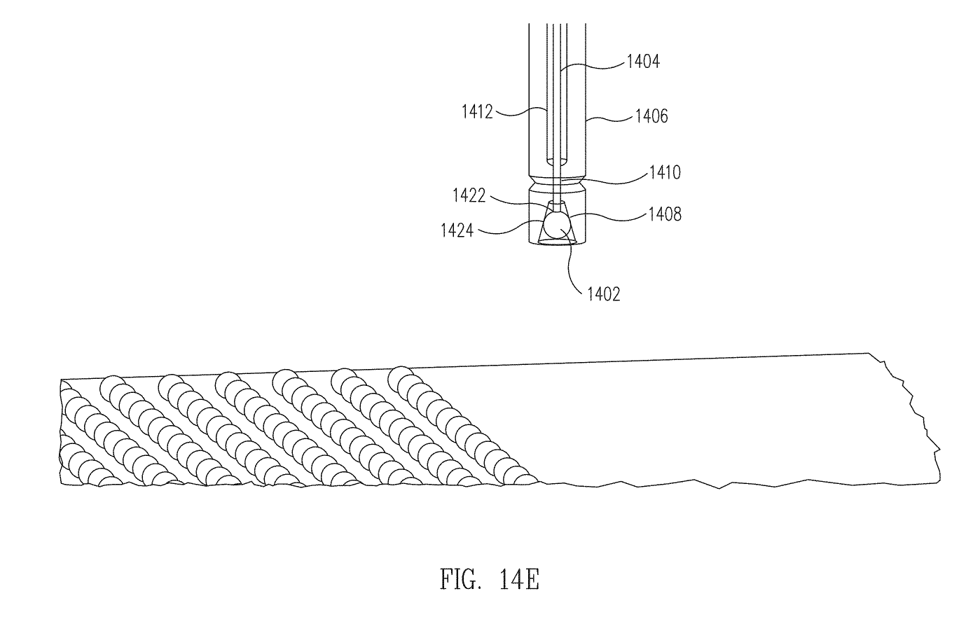

FIG. 14A is a block diagram of a process for assembling an optical component in accordance with an embodiment of the present disclosure. FIGS. 14B, 14C, 14D, and 14E, illustrate various operations of the process of FIG. 14A in accordance with embodiments of the present disclosure. Various steps of FIG. 14A may be illustrated by FIGS. 14B, 14C, 14D, and 14E.

In block 1401, connector design is prepared. Various aspects of the connector, such as design of the sleeve body, the optical fiber, the lens, and/or adhesives may be determined. Such design features may be similar to features described herein.

In block 1403 one or more lenses may be placed on the base. An optical fiber may then be placed in a channel of the sleeve body in block 1405 and inserted (e.g., threaded) through the channel either manually, through fiber fixture 1256B, or through another such technique. In optional block 1407, a tip of the optical fiber may be prepared to accept an optical adhesive. For example, a tip of the optical fiber may be cut or trimmed to expose an end of the optical fiber. Additionally, the tip and/or the first end may be polished, roughed up, treated (e.g., chemically), and/or otherwise prepared to accept the optical adhesive and/or the lens.

In block 1409, the optical adhesive may be applied to the first end of the optical fiber. In various embodiments, blocks 1403 to 1409 can be performed in any order and, thus, may be performed in an order different from that described in FIG. 14A.

FIG. 14B illustrates an example implementation of the operation of block 1409. As shown in FIG. 14B, optical fiber 1404 is inserted into a channel of sleeve body 1306. A first end of optical fiber 1406 may be prepared for and include an optical adhesive 1422 applied to first end 1422. Additionally, tray 1430 may include a plurality of lenses.

In certain embodiments, manufacturing fixture 1250 may hold sleeve body 1406 and/or optical fiber 1404 (e.g., sleeve fixture 1256A may hold sleeve body 1206 and fiber fixture 1256B may hold optical fiber 1404). Additionally, the manufacturing fixture may move (e.g., translate) to position sleeve body 1406 and optical fiber 1404 over lens 1402 in preparation for subsequent steps of the technique.

Continuing on to subsequent steps, in block 1411, the optical fiber is lowered to contact and partially adhere the lens. An example implementation of the operation of block 1411 may be illustrated in FIG. 14C, where the manufacturing fixture may lower optical fiber 1404 so that the first end and adhesive 1422 contacts lens 1402. Adhesive 1422 may partially adhere lens 1402 to optical fiber 1404 (e.g., lens 1402 may be coupled to optical fiber 1404, but may still move relative to optical fiber 1404).

In block 1413, the optical fiber may be raised while the lens is partially adhered to the lens. As the optical fiber is raised, the lens may move relative to the optical fiber. Thus, the center of gravity of the lens may be aligned to an optical path of the optical fiber, as described in block 1415. In certain embodiments, by raising the optical fiber with the lens partially adhered to the optical fiber, gravity may act on the center of gravity of the lens, pulling the lens so that the top (uppermost portion) of the lens is coupled to the optical fiber to align the center of gravity of the lens to the optical path of the optical fiber. Alignment of the lens to the optical fiber through such techniques allows for cost effective manufacture of optical communications equipment as such techniques can avoid expensive and complicated alignment jigs, equipment, and steps.

An example implementation of the operation of blocks 1413 and 1415 are illustrated in FIG. 14D. In FIG. 14D, the manufacturing fixture may raise optical fiber 1404, with lens 1402 partially adhered thereof, in direction 1440. Due to optical adhesive 1422, lens 1402 may be suspended from optical fiber 1404. While optical lens 1402 is suspended from optical fiber 1404 and partially adhered to optical fiber 1404, lens 1402 may be aligned to optical fiber 1404. For example, uncured optical adhesive 1422 may allow for lens 1402 to move relative to optical fiber 1404 so that gravity acts on the center of gravity of lens 1402 and moves lens 1402 so that a center of gravity of lens 1402 is aligned with an optical path of the optical fiber 1404. As lens 1402 is suspended from optical fiber 1404, such alignment may be performed without lens 1402 decoupling from optical fiber 1404. Additionally, lens 1402 may move to align itself with optical fiber 1404 and, when properly aligned, the top (uppermost portion) of lens 1402 is coupled to optical fiber 1404 and, thus, ceases further movement of lens 1402 relative to optical fiber 1404.

In certain embodiments, a sensor (e.g., sensor 1252) may detect when the lens is properly aligned with the optical fiber. In other embodiments, the lens may be allowed to align itself to the optical fiber within a certain period of time. Such a period of time may be generally sufficient for the lens to be aligned to the optical fiber. Upon detecting and/or completion of alignment of the lens to the optical fiber, in block 1417, the optical adhesive may be cured to fully adhere the lens to the optical fiber. The optical adhesive may be cured through drying of the optical adhesive and/or with an apparatus such as UV source 1254. For example, UV source 1254 may provide UV light to the optical adhesive to cure the optical adhesive.

After the optical adhesive is cured, in block 1419, the optical fiber may be drawn so that the lens is disposed within the recess. While the lens is drawn into the recess, features of the recess, such as a taper of the recess, may align the lens within the recess. In block 1421, the lens may be set within the recess. The lens may be set through a friction fit, through adhesive, through mechanical fasteners (e.g., a cover may be provided over the open end of the recess), and/or through other techniques.

Blocks 1419 and 1421 are illustrated in FIG. 14E, where optical fiber 1404 has been drawn so that lens 1402 is disposed within recess 1408. Recess 1408 may include a tapered surface that is configured to align lens 1402 within recess 1408. Once aligned, lens adhesive 1424 may be applied to recess 1408 and lens 1402 to adhere lens 1402 to recess 1408. In certain other embodiments, lens adhesive 1424 may be applied to recess 1408 before lens 1402 is disposed within recess 1408 or may not be applied at all. Lens adhesive 1424 may be cured after lens 1402 is disposed and aligned within recess 1408. In embodiments where lens adhesive is not applied at all, one or more other techniques may be used to hold lens 1402 within recess 1408.

After the lens is aligned and coupled to the optical fiber and disposed within the recess, one or more tests can be performed to determine the quality of the optical fiber and lens alignment in block 1423. For example, one or more optical signals may be provided to an end of the optical fiber (e.g., an end opposite the first end of the optical fiber that is coupled to the lens). The optical signal may then be transmitted to the lens and the lens may project a free space optical beam based on the optical signal. The free space optical beam may have a substantially parallel shape and a substantially Gaussian power density distribution. The free space optical beam can be received by a testing apparatus and/or another lens and analyzed. The strength of the free space optical beam can then be determined. The measured strength may then indicate the quality of the optical fiber and lens alignment.

Before or after testing in block 1423, optional block 1425 may be performed. In optional block 1425, for optical connector that are assembled from one or more sleeve bodies, an assembled sleeve body that includes an optical fiber and a lens can be assembled into an optical connector. The sleeve body can be coupled to the optical connector and additional operations can be performed to fully manufacture the optical connector.

FIG. 15A illustrates an alignment of a lens to an optical fiber in accordance with an embodiment of the present disclosure. As shown in FIG. 15A, optical fiber 1504 may include optical path 1592. Optical path 1592 may be a path within which optical signals and/or beams may be transmitted in optical fiber 1504. Optical signals and/or beams may be transmitted so that such signals and/or beams generally follow optical path 1592. In certain embodiments, such signals and/or beams may be reflected between the sidewalls of optical fiber 1504.

A center of gravity 1590 of lens 1502 may be aligned with optical path 1592. As shown, center of gravity 1590 is aligned with optical path 1592 by being disposed within a projection of optical path 1592. Such an alignment may maintain optical beam power loss within optical fiber 1504 and lens 1502, as well as between two lenses, below a power loss threshold and, thus, allow for more efficient transmission of optical data.

The systems and techniques described herein may be used to cost effectively manufacture optical connectors. The techniques may be used with existing manufacturing lines (e.g., pick and place machines or manufacturing robots) and may accurately align lenses to optical fibers. Such alignment may improve performance of optical connectors by allowing for better alignment between optical fibers and lenses, decreasing power loss and increasing data transfer.

Such transmission is illustrated in FIG. 15B. FIG. 15B is a plot of a transmission losses associated with various lens alignments in accordance with an embodiment of the present disclosure. As shown in FIG. 15B, the x-axis is directed to misalignment of lenses in nanometers and the y-axis is directed to power loss in decibels. Power loss is generally between 7 to 9 decibels when misalignment is within 150 nanometers, but when misalignment is greater than 150 nanometers, power loss increases substantially.

The foregoing disclosure is not intended to limit the present invention to the precise forms or particular fields of use disclosed. As such, it is contemplated that various alternate embodiments and/or modifications to the present disclosure, whether explicitly described or implied herein, are possible in light of the disclosure. For example, embodiments with one or two optical connections are described, but a person skilled in the art will understand that the present disclosure may cover any number of optical connections that are physically supportable by the host device. Having thus described embodiments of the present disclosure, persons of ordinary skill in the art will recognize advantages over conventional approaches and that changes may be made in form and detail without departing from the scope of the present disclosure. Thus, the present disclosure is limited only by the claims.

What is claimed is:

1. A method comprising:
applying an optical adhesive to a first end of the optical fiber;
translating the optical fiber towards a lens to at least partially adhere the end of the optical fiber to the lens by the optical adhesive; and
suspending the lens from the optical fiber to align a center of gravity of the lens with an optical path of the optical fiber to maintain optical beam power loss below a power loss threshold.

2. The method of claim 1, further comprising:
providing an optical sleeve comprising a sleeve body including a channel and a recess disposed on a first end of the sleeve body in communication with the channel;
passing, prior to the translating, the optical fiber through the channel and the recess to extend a portion of the optical fiber from the first end; and
drawing the optical fiber back through the channel to position the lens in the recess.

3. The method of claim 2, further comprising:
applying a lens adhesive to the recess to secure the lens within the recess.

4. The method of claim 2, wherein the lens is a substantially spherical lens and the recess is a substantially conical recess configured to receive the lens, and wherein the method further comprises:
forming, with the optical sleeve including the optical fiber and the lens positioned within the recess, an optical connector configured to project a free space optical beam from the lens in response to an optical signal provided to the optical fiber.

5. The method of claim 1, further comprising:
curing the optical adhesive.

6. The method of claim 1, further comprising:
cutting the optical fiber, prior to applying the optical adhesive, to expose the first end of the optical fiber.

7. The method of claim 1, further comprising:
providing an optical signal to the optical fiber to project, by the lens, a free space optical beam having a substantially parallel shape and a substantially Gaussian power density distribution; and
analyzing the free space optical beam.

8. A system comprising:
a fiber fixture configured to receive an optical fiber;
an actuator configured to cause the fiber fixture to move the optical fiber; and
a controller communicatively connected to the sleeve fixture, the fiber fixture, and the actuator and configured to cause the system to:
translate, by operating the actuator, the optical fiber received by the fiber fixture towards a lens to at least partially adhere the end of the optical fiber to the lens by the optical adhesive;
raise, by operating the actuator, the optical fiber while the lens is partially adhered to the optical fiber; and
suspend the lens from the optical fiber to align a center of gravity of the lens with an optical path of the optical fiber to maintain optical beam power loss below a power loss threshold.

9. The system of claim 8, further comprising a sleeve fixture and wherein the controller is further configured to:
receive, with the sleeve fixture, the optical sleeve comprising a sleeve body including a channel and a recess disposed on a first end of the sleeve body in communication with the channel;
pass, prior to the translating, the optical fiber through the channel and the recess to extend a portion of the optical fiber from the first end; and
draw, by operating the actuator, the optical fiber back through the channel to position the lens in the recess.

10. The system of claim 9, further comprising an adhesive applicator and wherein the controller is further configured to:
apply a lens adhesive to the recess to secure the lens within the recess.

11. The system of claim 9, wherein the lens is a substantially spherical lens and the recess is a substantially conical recess configured to receive the lens, and wherein the controller is further configured to:
insert, by moving the sleeve fixture, the optical sleeve, including the optical fiber and the lens positioned within the recess, into an optical connector configured to project a free space optical beam from the lens in response to an optical signal provided to the optical fiber.

12. The system of claim 8, further comprising an ultraviolet source communicatively connected to the controller and wherein the controller is further configured to:
cure the optical adhesive with the ultraviolet source.

13. The system of claim 8, further comprising a cutter and an adhesive applicator communicatively connected to the controller and wherein the controller is further configured to:
cut the optical fiber to expose the first end of the optical fiber with the cutter; and
apply the optical adhesive to the first end of the optical fiber with the adhesive applicator.

14. The system of claim 8, further comprising a position sensor and wherein the controller is further configured to:
detect, with the position sensor, when the center of gravity of the lens is aligned with an optical path of the optical fiber.

15. An apparatus comprising:
a sleeve body comprising a channel and a recess disposed on a first end of the sleeve body in communication with the channel;
an optical fiber disposed within the channel; and
a lens disposed within the recess and coupled to a first end of the optical fiber via an optical adhesive, wherein a center of gravity of the lens is substantially aligned with an optical path of the optical fiber, by suspension from the optical fiber during manufacture, to maintain optical beam power loss below a power loss threshold.

16. The apparatus of claim 15, wherein the recess comprises a substantially conical shape configured to align the lens within an alignment threshold within the recess.

17. The apparatus of claim 15, wherein the channel comprises a first portion with a first cross-sectional area and a second portion with a second cross-sectional area, wherein the first portion is disposed closer to the recess than the second portion, and wherein the first cross-sectional area is smaller than the second cross-sectional area.

18. The apparatus of claim 15, wherein the lens is a ball lens.

19. The apparatus of claim 15, wherein the lens is coupled to the lens opening via a lens adhesive.

20. The apparatus of claim 15, wherein a diameter of the lens is at least four times larger than a diameter of the optical fiber, the diameter of the lens is less than 2 millimeters, and a refractive index of the fiber and/or the ball lens is three or less.
